(19) United States
(12) Patent Application Publication
(10) Pub. No.: US 2025/0277063 A1
(43) Pub. Date: Sep. 4, 2025

(54) STARCH COMPOSITIONS MADE USING SATURATED STEAM

(71) Applicant: CORN PRODUCTS DEVELOPMENT, INC., WESTCHESTER, IL (US)

(72) Inventors: Nils KILGAST, Hamburg (DE); Markus BEIER, Hamburg (DE); David WENZEL, Hamburg (DE); Julika BASEDA, Hamburg (DE)

(21) Appl. No.: 18/702,544

(22) PCT Filed: Oct. 11, 2022
(86) PCT No.: PCT/US2022/046217

§ 371 Date: Apr. 18, 2024

Related U.S. Application Data
(60) Provisional application No. 63/271,329, filed on Oct. 25, 2021.

(51) Int. Cl. C08B 30/12; A23L 29/212; C08L 3/02

(52) U.S. Cl. CPC C08B 30/12; A23L 29/212; C08L 3/02

(57) ABSTRACT

This specification discloses methods for processing starch by applying a hot aqueous fluid to the starch in an amount up to about 45% (wt. % of the starch). Depending on the among of fluid the processes may be used to agglomerate the starch or to precook or pregelatinize the starch. The method is useful applied to native and modified starches and particularly useful for pregelatinizing or agglomerated thermally inhibited starch having a moisture content less than about 2% (wt. % of the starch).

This specification discloses a method for processing starch or flour products using limit amount of water, which may be applied as saturated steam. In at least some embodiments the process is applied to an anhydrous starch or flour product to obtain one or more of an agglomerated product, a pre-cooked product, and a pregelatinized product.

Starch is a polymer made by plants to store glucose. Starch is primarily present in certain plant organs, for example a seed or tuber. The plant organ can be milled to form a flour and the starch can be separated from the flour to obtain essentially pure starch. Although the other parts of flour, for example protein, may affect the function of the flour in food products, the starch within the flour behaves essentially like isolated starch. So for convenience, within this specification, reference to starch includes reference to essentially pure starch and to flour unless said otherwise. For example, this specification may refer to flour to mean products comprising starch and greater than about 1% protein or it may refer to essentially pure starch products having less than about 1% protein.

Starch is a common food ingredient that is granular in its native form. Native starch is insoluble in water and settles from a slurry readily. But if heated in aqueous fluid (for example during cooking) starch granules hydrate, swell, and eventually fragment releasing the starch polymers amylose and amylopectin. The foregoing process is called gelatinization and the end-product is called a gelatinized starch.

Each of the stages of gelatinization can be useful in food making processes. In some food making processes it can be useful to have uncooked starch that will be cooked during processing. In other food making processes it can be useful to use precooked starch. Precooking starch at least begins the gelatinization process so that the precooked starch is subsequently easier to completely cook when processed, and in some cases removes the need for further cooking of the starch. For example, precooked starch is more likely to swell during cooking or is more easily dispersed or swells readily in cold water or is soluble in cold water, compared to uncooked starch, or some combination of these attributes. Starch that is pre-cooked to the point of gelatinization, recovered as a solid product, and can be used in a food making process is called pregelatinized starch. For simplicity, within the specification, the term precooked starch means starch that is precooked to any degree up to and including precooking the starch until it is completely pregelatinized.

Also, starch can be modified so that it provides consistent, predictable texture during a food making process. Many starch modifications are known and commonly used in the art including chemical modifications, physical modifications, and enzymatic modification. It is also common and sometimes useful to precook or pregelatinized modified starch for the same reasons it is useful to precook or pregelatinize native starch.

Both native and modified starch are commonly precooked (and pregelatinized) using various methods. Two are drum drying or spray drying, which use large volumes of water. For example, the first step of drum drying or spray cooking is to make a starch slurry, which is a two-phase composition, meaning there are two states of matter. Namely in a starch slurry there is a solid phase of starch and a liquid phase of liquid water or other aqueous liquid. Drum drying or spray drying cook the starch or flour but also must evaporate the excess water, which is energy intensive.

The methods disclosed in this specification improve on prior pre-cooking technologies by using a single-phase process, meaning all aqueous fluid used to cook the starch is absorbed by the starch so that only a single solid starch phase is present during the cooking process. The aqueous fluid may be applied as hot water or hot aqueous liquid or as saturated steam. The single-phase systems cook the starch in smaller volume of water than is necessary to drum dry or spray cook starch. The methods described herein are applicable to both native and modified starch and are useful for pregelatinizing starch. In preferred embodiments, the methods described in this specification can be applied to thermally inhibited starches, including to thermally inhibited starch in its anhydrous state, to pregelatinize the thermally inhibited starch. Also disclosed in this specification are precooked starches made according to the described methods described in this specification.

### BRIEF DESCRIPTION OF THE FIGURES

FIG. 1 is a photograph of drum dried thermally inhibited waxy cassava starch, stained and viewed at 100× magnification under polarized light.

FIG. 2 is a photograph of spray dried thermally inhibited waxy cassava starch, stained and viewed at 100× magnification under polarized light.

In any embodiment described in this specification, a starch is processed in a method (being a single-phase method) comprising providing a starch and applying a hot aqueous fluid to the starch in an amount up to about 45% (wt. % of the starch). In some embodiments the hot fluid is applied as water or aqueous liquid having temperature near to or at the boiling point of water. In at least some embodiments of the method disclosed in this specification a hot aqueous liquid has a temperature from about 70° C., or from about 75° C., or from about 80° C., or from about 85° C., or from about 90° C., or from about 95° C., to about 99° C., or from about 70° C. to about 99° C., or to about 95° C., or to about 90° C., or to about 85° C., or to about 80° C., or to about 75°. In other embodiments the hot aqueous fluid is applied as saturated steam or has a temperature greater than about 100° C., or greater than about 110° C., or greater than about 120° C. 100° C. or greater than about 110° C. or greater than about 120° C. or from about 100° C. to about 200° C. or to about 190° C. or to about 180° C. or to about 170° C. or to about 160° C. or to about 150° C. In at least some embodiments the hot aqueous fluid is applied to a starch having a moisture content less than about 2% (wt. %).

In various embodiments of the methods described in this specification, the hot aqueous fluid can be applied to starch in different amounts to obtain different effects. In some embodiments, hot aqueous fluid is applied to a starch in an amount from about 10% to about 20% or from about 10% to about 15% of the starch (wt. %). In such embodiments, the hot aqueous fluid makes an agglomerated starch, which is a composition comprising more than one or more adhered starch granule. In some embodiments this specification discloses a method for agglomerating starch by applying saturated steam to the starch in an amount from about 10% to about 20% or from about 10% to about 15%. In other embodiments this specification discloses a method for agglomerating starch by applying a hot aqueous liquid to the starch in an amount from about 10% to about 20% or from about 10% to about 15%, wherein the liquid has a temperature from about 70° C., or from about 75° C., or from about 80° C., or from about 85° C., or from about 90° C., or from about 95° C., or to about 99° C., or from about 70° C. to about 99° C., or to about 95° C., or to about 90° C., or to about 85° C., or to about 80° C., or to about 75° C. In at least some embodiments the moisture is applied to a starch having a moisture content less than about 2% (wt. %).

In other embodiments, hot aqueous fluid is applied to a starch in an amount from about 20%, or from about 25%, or from about 30%, or from about 35% to about 45%, or to about 40% (wt. % of the starch). In such embodiments the hot aqueous fluid precooks the starch. In some embodiments described, the process pregelatinizes the starch.

In some embodiments, this specification discloses a method of precooking a starch comprising applying saturated steam to a starch in an amount from about 20%, or from about 25%, or from about 30%, or from about 35%, to about 45% or to about 40% (wt. % of the starch). In other embodiments, this specification discloses a method of pregelatinizing a starch comprising applying saturated steam to a starch in an amount from about 20%, or from about 25%, or from about 30%, or from about 35% to from about 45%, or to about 40% (wt. % of the starch).

In still other embodiments this specification discloses a method of precooking a starch comprising applying hot aqueous liquid having to a starch in an amount from about 20%, or from about 25%, or from about 30%, or from about 35% to about 45%, or to about 40% (wt. % of the starch). In still other embodiments, this specification discloses a method of pregelatinizing a starch comprising applying saturated steam to a starch in an amount from about 20%, or from about 25%, or from about 30%, or from about 35% to about 45%, or to about 40% (wt. % of the starch). In embodiments using a hot aqueous liquid, the liquid has a temperature from about 70° C., or from about 75° C., or from about 80° C., or from about 85° C., or from about 90° C., or from about 95° C. to about 99° C., or from about 70° C. to about 99° C., or to about 95° C., or about to 90° C., or to about 85° C., or to about 80° C., or to about 75° C.

In any embodiment described in this specification, following agglomeration, precooking or pregelatinization, the agglomerated, or precooked, or pregelatinized starch may be dried to have a moisture content of up to about 15% or from about 4%, or from about 6%, or from about 8% to about 15%, or to about 12% (wt. of the starch), or to the equilibrium moisture content of the native starch.

In various embodiments the starch provided to be agglomerated, precooked, or pregelatinized is from any suitable botanical source, including but not limited to corn, waxy corn, rice, waxy rice, tapioca, waxy tapioca, potato, waxy potato, pea, chickpea, lentil, fava bean, quinoa, sago, and mixtures thereof.

In various embodiments the starch to be agglomerated, or precooked, or pregelatinized is a native starch.

In various embodiments, the starch to be agglomerated, precooked, or pregelatinized is a modified starch. The modified starch may be modified using any method known in the art that is used to modify starch. Common starch modifications include, but are not limited to, chemical modifications like crosslinking using adipic acid or anhydride, POCl₃, or sodium trimetaphosphate. Other chemical modifications include addition of chemical moieties to the starch for example using propylene oxide, or acetic acid, or acetic anhydride, or succinic acid, or octenyl-succinic acid. Modified starch does not need to be edible to be used for the processes disclosed herein, for example, cationic, anionic, and silicon-based moieties can be added. Starch can be hydrolyzed using acid or base or enzyme. Starch can be oxidized. Starch can be physically modified using various heat and moisture processes such has annealing, thermal inhibition, or other type of heat-moisture treatment. In at least some embodiments the starch to be agglomerated, or precooked, or pregelatinized using the processes described in this specification is a modified starch, preferably a thermally inhibited starch having moisture content of less than about 2% (wt. % of the starch).

With reference to modified starches to be agglomerated, precooked, or pregelatinized, any process to modify the starch may be used to provide the base material. In at least some methods the starch is modified in the same reactor used to agglomerate, precook, or pregelatinize the starch. Examples of useful reactors include fluidizing bed reactors (also called fluid bed reactors) and hollow-tube reactors, like CoriMix reactors available from Loedige. The modification reaction may react a base starch with a reactant in a gas phase. In hollow tube reactors the reactant may be liquid but is applied to the starch in an amount less than is needed to form a slurry—i.e. in a single-phase process where starch absorbs all the liquid. In such single-phase processes, the moisture content of the starch increases and the starch may appear wet or be in the form a starch cake, but the starch remains a powdered material and is not dispersed in a liquid. Depending on the layout of reactors, the starch may be modified and precooked or modified and pregelatinized or modified and agglomerated in the same reactor, or in a series of reactors in a continuous manner. In other embodiments starch may be modified and precooked or modified and pregelatinized or modified and agglomerated in batches in one or more reactors.

In at least some embodiments, the base starch used to be agglomerated, or precooked, or a pregelatinized is a thermally inhibited starch. Thermal inhibition processes alter a starches function so that it functions in aqueous solution like chemically crosslinked starch. Various methods are known for thermally inhibiting starch. Useful methods are described in WO 2020-139997 (which is incorporated herein in its entirety). Generally, thermally inhibited starch is made by soaking a native starch in a liquid containing a buffering agent, commonly the salt of an organic acid or base. The starch is soaked to allow the buffer to move into the starch granule. Buffered starch is then pH adjusted, depending on the buffer used, to have a pH in a range from about 4 to about 9.5. The buffered, pH adjusted starch is then dehydrated to have a moisture content less than about 2% (wt. % of the starch) and heated to a temperature from about 100° C. to about 200° C. for enough time to obtain a desired degree of thermal inhibition. The resulting thermally inhibited starch is essentially anhydrous, having been dehydrated to moisture content less than 2% and then further heated above the boiling point of water for enough time to thermally inhibit the starch.

In some embodiments the methods described in this specification apply hot aqueous fluid to the essentially anhydrous thermally inhibited starch obtained at the end of the thermal inhibition process. In other embodiments the thermally inhibited starch is cooled allowing the starch to absorb moisture from the atmosphere before using the agglomerating and precooking methods described in this specification. In various embodiments of the methods described in this specification for agglomerating, precooking, or pregelatinizing a thermally inhibited starch, the hot aqueous fluid is applied to a thermally inhibited starch starting material having moisture content less than about 2% (wt. % of the starch).

In various embodiments described in this specification hot aqueous fluid is applied to a thermally inhibited starch in amount to obtain thermally inhibited agglomerated starch, or in an amount to obtain a precooked or pregelatinized thermally inhibited starch, or in an amount to obtain a precooked or pregelatinized and agglomerated thermally inhibited agglomerated starch.

Referring first to agglomerating processes, in any embodiment, this specification describes a method for thermally inhibiting an agglomerated starch, meaning a starch is agglomerated and then the agglomerated starch is thermally inhibited. The starch starting material may be a native starch or may be a pregelatinized starch. If pregelatinized, the starch can be (preferably is) pregelatinized using the processes described this specification. In any embodiment described in this specification a method for thermally inhibiting an agglomerated starch comprises providing a starch and applying a hot aqueous fluid to the starch in an amount from about 10% to about 20%, or from about 10% to about 15% (wt. % of the starch), wherein the hot aqueous fluid comprises a buffering agent, and an acid or a base. The hot aqueous fluid agglomerates the starch and adjusts the pH of the starch to a pH between about 4.0 and about 9.5. The process further comprises dehydrating the agglomerated, buffered, pH adjusted starch to a moisture content of less than about 2% (wt. % of the starch) and heat treating the dehydrated starch agglomerates at a temperature of about 100° C. to about 200° C. for up to about 20 hours thereby thermally inhibiting the starch agglomerates to obtain a thermally inhibited agglomerated starch. In some embodiments of the method described in this paragraph, the starch is buffered, and pH adjusted by applying a hot aqueous liquid to the starch to obtain a starch having a pH range from about 4.0 to about 7.0, and more preferably, to a pH range pH from about 4.0 or from about 4.5 to about 6.5 or to about 5.5.

Following thermal inhibition, the thermally inhibited starch may be remoistened using any known technology. In some embodiments the thermally inhibited agglomerated starch is remoistened by washing the thermally inhibited agglomerated starch in enough moisture to form a slurry followed by drying the thermally inhibited agglomerated starch to a moisture content from about 4% or from about 6% or from about 8% to about 15% or to about 12% (wt. % of the starch).

In other embodiments, this specification describes methods for agglomerating thermally inhibited starch, meaning the starch is thermally inhibited and then agglomerated using the methods described in this specification. In such embodiments, the starting thermally inhibited starch is thermally inhibited to any degree desirable using any known thermal inhibition process. Degree of thermal inhibition can be measured using a micro-visco-amylograph test that measures changes in viscosity over time of an aqueous starch slurry of defined pH and starch solids content as the slurry is heated.

In any embodiment described in this specification, thermally inhibited starch used as a starting material to obtain agglomerated thermally inhibited starch has a hot peak viscosity that is less than about 2000 mPa*s or less than 1500 mPa*s (as measured using the micro-visco-amylograph test defined in this specification). In at least some embodiments the starting thermally inhibited starch has a peak hot viscosity in a range selected from the group consisting of a) less than about 300 mPa*s, b) from about 300 mPa*s to about 800 mPa*s, and c) from about 800 mPa*s to about 1600 mPa*s.

In any embodiment, this specification describes a method comprising applying saturated steam to a thermally inhibited starch in an amount from about 10% to about 20% (wt. % of the starch), or from about 10% to about 15% to obtain an agglomerated thermally inhibited starch, and if necessary, drying the agglomerated thermally inhibited starch to a moisture content of up to about 15% or from about 4%, or from about 6%, or from about 8% to about 15%, or to about 12% (wt. % of the starch), or to the equilibrium moisture content of the native starch. Preferably the thermally inhibited starch starting material has moisture content less than about 2% (wt. % of the starch).

In any embodiment, this specification describes a method comprising applying a hot aqueous liquid to a thermally inhibited starch in an amount from about 10% to about 20% wt. % of the starch, or from about 10% to about 15% to obtain an agglomerated thermally inhibited starch, and if necessary, drying the agglomerated thermally inhibited starch to a moisture content of up to about 15% or from about 4%, or from about 6%, or from about 8% to about 15%, or to about 12% (wt. % of the starch). In embodiments using a hot aqueous liquid, the liquid has a temperature from about 70° C., or from about 75° C., or from about 80° C., or from about 85° C., or from about 90° C., or from about 95° C. to about 99° C., or from about 70° C. to about 99°, or to about 95° C., or about to 90° C., or to about 85° C., or to about 80° C., or to about 75° C. Preferably the thermally inhibited starch starting material has moisture content less than about 2% (wt. % of the starch).

With reference now to methods for precooking and pregelatinizing a thermally inhibited starch, the starch starting starch material is thermally inhibited starch that is thermally inhibited using any process and to any desired degree of thermal inhibition. The starting thermally inhibited starch may also be an agglomerated thermally inhibited starch or thermally inhibited agglomerated starch.

In any embodiment, this specification describes a method comprising applying saturated steam to a thermally inhibited starch in an amount in an amount from about 20% or from about 25%, or from about 30%, or from about 35% to about 45% or to about 40% (wt. % of the starch). to obtain a precooked or pregelatinized thermally inhibited starch; wherein optionally, the precooked or pregelatinized thermally inhibited starch is then dried to a moisture content of up to about 15% or from about 4%, or from about 6%, or from about 8% to about 15%, or to about 12% (wt. % of the starch), or to the equilibrium moisture content of the native starch. Preferably in such embodiments the thermally inhibited starch starting material has moisture content less than about 2% (wt. % of the starch).

In any embodiment, this specification describes a method comprising forming an agglomeration of thermally inhibited starch by applying saturated steam to a thermally inhibited starch in a first amount, which is up to about 45% (wt. % of the starch); and pregelatinizing the agglomerated thermally inhibited starch by applying saturated steam to the thermally inhibited agglomerated starch in an second amount which is greater than the first amount but is up to about 45% (wt. % of the starch); wherein, optionally, the pregelatinized agglomerated thermally inhibited starch is then dried to a moisture content dried to a moisture content of up to about 15% or from about 4%, or from about 6%, or from about 8% to about 15%, or to about 12% (wt. % of the starch). Preferably in such embodiments the thermally inhibited starch starting material has moisture content less than about 2% (wt. % of the starch).

In any embodiment, this specification describes a method comprising applying a hot aqueous liquid to a thermally inhibited starch in an amount from about 20%, or from about 25%, or from about 30%, or from about 35% to about 45% or to about 40% (wt. % of the starch) to obtain a precooked or pregelatinized thermally inhibited starch; wherein optionally, the precooked or pregelatinized thermally inhibited starch is then dried to a moisture content of up to about 15% or from about 4%, or from about 6%, or from about 8% to about 15%, or to about 12% (wt. of the starch), or to the equilibrium moisture content of the native starch. Preferably the thermally inhibited starch starting material has moisture content less than about 2% (wt. % of the starch). In embodiments using a hot aqueous liquid, the liquid has a temperature from about 70° C., or from about 75° C., or from about 80° C., or from about 85° C., or from about 90° C., or from about 95° C. to about 99° C., or from about 70° C. to about 99° C., or to about 95° C., or about to 90° C., or to about 85° C., or to about 80°, or to about 75° C.

In any embodiment, this specification describes a method comprising forming an agglomeration of thermally inhibited starch by applying a hot aqueous liquid to a thermally inhibited starch in a first amount, which is up to about 45% (wt. % of the starch); and precooking or pregelatinizing the agglomerated thermally inhibited starch by applying a hot aqueous liquid to the thermally inhibited agglomerated starch in an second amount which is greater than the first amount but is up to about 45% (wt. % of the starch); wherein, optionally, the precooked or pregelatinized agglomerated thermally inhibited starch is then dried to a moisture content dried to a moisture content of up to about 15% or from about 4%, or from about 6%, or from about 8% to about 15%, or to about 12% (wt. % of the starch). Preferably the thermally inhibited starch starting material has moisture content less than about 2% (wt. % of the starch). In embodiments using a hot aqueous liquid, the liquid has a temperature from about 70° C., or from about 75° C., or from about 80° C., or from about 85° C., or from about 90° C., or from about 95° C. to about 99° C., or from about 70° C. to about 99° C., or to about 95° C., or about to 90° C., or to about 85° C., or to about 80° C., or to about 75° C.

Advantageously, the described methods for agglomerating, precooking, and pregelatinizing thermally inhibited starch allow for saturated steam or hot aqueous liquid to be applied to thermally inhibited starch after the heating phase of a thermal inhibition process. In some embodiments, therefore, the processes for agglomerating, precooking and pregelatinizing thermally starch can be applied to the thermally inhibited starch without the need to move the thermally inhibited starch to a different reactor from where it was thermally inhibited. In some embodiments the hot aqueous fluid can be applied to the thermally inhibited starch without allowing the starch to cool and absorb at least some ambient moisture. In any embodiment hot aqueous fluid can be applied to thermally inhibited starch having a moisture content of less than about 2% (wt. % of the starch).

Thermally inhibited starches obtainable from the methods described in this specification, whether agglomerated, precooked, or pregelatinized or some combination thereof, can be washed and dried to obtain a desired end moisture content, remoistened in a single-phase process to obtain the desired moisture content, or let cool and remoisten under ambient conditions without use of a washing or a single-phase remoistening step.

In any embodiment a starch may be dried, and agglomerated, precooked, or pregelatinized in the same reactor, or same type or reactor or in different reactors or different types of reactors.

In any embodiment a starch may be dried, and agglomerated, precooked, or pregelatinized in a continuous process or in batches.

Reactors useful for agglomerating, or precooking, or pregelatinizing starch are enclosed reactors capable of applying hot aqueous fluid to a starch. Useful reactors include fluid bed reactors, which can be set up to agglomerate, precook, or pregelatinize starch in batches or be configured to process starch in a continuous process. Fluid (or fluidizing bed reactors) are hollow vessels with ports that inject gas into the vessel to disperse a powdered material, like starch, within the space of the vessel so that the starch takes on fluid-like properties. Various gases can be injected included air, or, saturated steam, or dispersed liquid, which can be injected in amounts to provide the weight percentage of aqueous fluid relative starch. The gases can be heated, and/or the hollow vessel of the fluid bed reactor can be jacketed or provide other heating mechanism so that the temperature aqueous fluid and starch is maintained at the levels described in this specification.

Other suitable reactors include hollow tube reactors comprising a blade that presses material against the inside of the hollow tube, or a screw-like device or other device that impels material through the length of the reactor through rotation or otherwise. Such reactors include various openings through which starch, or steam, liquid aqueous solution, liquid water, or other material can be put into the hollow tube. In practicing the methods described in this specification, the rate of flow starch, aqueous fluid, etc. entering and passing through the hollow tube is metered so that weight percent of aqueous fluid relative starch is at the levels described in this specification. Such reactors may be jacketed or comprise other mechanisms to heat the materials within the hollow tube so that the temperature of fluid and starch is maintained at the levels described in this specification. In at least some embodiments useful reactors are ring layer type or ring dryer type reactors. Such reactors of this type are available from various vendors including but not limited to Lödige Process Technology, Paderborn, Germany, GEA Barr-Rosin, Hudson, Wisconsin, USA, or Bepex International LLC, Minnesota, USA. Useful reactors may be known in the industry by names such as Horizontal Ploughshare Mixers, Littleford Agitated Vacuum Dryers, CoriMix mixers. The foregoing list is intended to be illustrative as to types of reactors and is not limiting.

Also disclosed in this specification are starches made using any process described in this specification. In at least some embodiments a starch obtained by the described process is a pregelatinized starch or pregelatinized thermally inhibited starch. In preferred embodiments a starch made by the processes described in this specification is pregelatinized in a hollow-tube reactor. Starch pregelatinized in a hollow tube is distinguishable from starch pregelatinized using methods like drum drying and spray cooking by viewing the starch in solution under magnification because of the varying levels of shear applied to the starch during pregelatinization. Shear applied during pregelatinization tears the starch particles resulting in many fragmented particles and provides starch granules that have generally jagged edges.

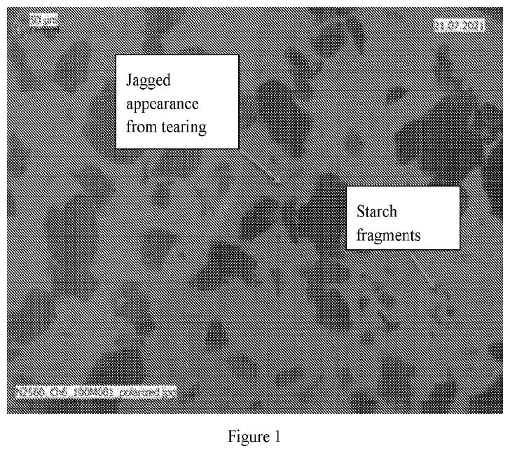

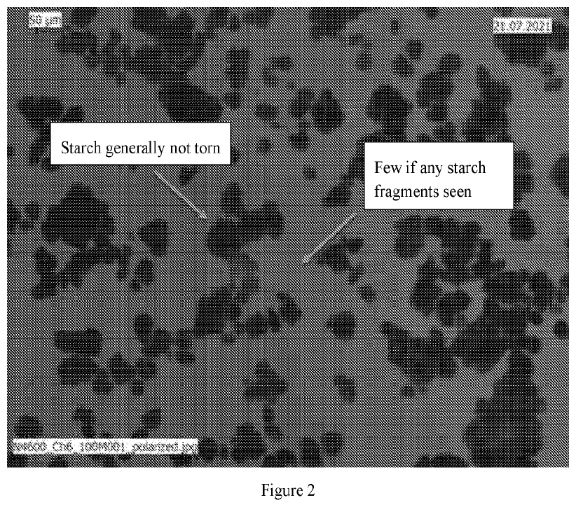

Drum drying is a relatively high shear process. A picture of drum dried pregelatinized thermally inhibited starch (100× magnification using a polarized filter) is presented in FIG. 1. Spray cooking is a relatively low shear process, compared to the drum drying process. FIG. 2 presents a picture of a spray cooked pregelatinized thermally inhibited starch. Compared to FIG. 1, the starch of FIG. 2 has generally intact particles having comparatively smooth perimeters or edges. The processes for pregelatinizing starch and pregelatinizing thermally inhibited starch described in this specification apply shear differently than drum drying and spray drying because using the described process shear is applied to the thermally inhibited starch in a system where all the aqueous fluid is absorbed by the starch during cooking and shearing. In contrast for both drum drying and spray cooking the starch is cooked and sheared in slurry having solid starch phase of starch dispersed in a separate liquid phase. Using the methods described in this specification to apply shear during pregelatinization provides pregelatinized starches and pregelatinized thermally inhibited starches having a differentiated texture and appearance than starches and thermally inhibited starches pregelatinized using spray drying compared to thermally inhibited starches pregelatinized using drum drying.

In some embodiments, this specification describes pregelatinized thermally inhibited starch, and pregelatinized agglomerated thermally inhibited starch made according to the process as described in any foregoing claim. Agglomerated pregelatinized starches described in this specification disperse well in aqueous solutions, at least because the aqueous solution disrupts the ability of the binding agent holding the agglomerated starch granules together. (Without being bound by theory, it is believed that small amounts of starch are partially cooked and made water soluble during the agglomeration processes described in this specification, this solubilized starch when dries is then able to bind separate starch granules together.) When the starch agglomerates are added to water, the water dissolve the binding between the granules causing and leading to the breakdown of the surface tension otherwise holding the starch particles together, which tends to disperse the starch.

Additionally, in preferred embodiments of the methods described in this specification, an agglomeration or pregelatinization processes does not destroy the desired functionality of the starch used in the process. In at least some embodiments the pregelatinized agglomerated thermally inhibited starch provides viscosity to cold aqueous solutions—i.e. without need for further heating. In any embodiment described in this specification a thermally inhibited starch that is agglomerated, pregelatinized, or both, using the processes described in this specification provides starch slurry having 6% starch and pH 6 with a viscosity, without heating, in a range selected from the group consisting of a) less than about 300 mPa*s, b) from about 300 mPa*s to about 800 mPa*s, and c) from about 800 mPa*s to about 1600 mPa*s.

Also described in this specification are food compositions comprising a starch that is made using the methods described in this specification. In some embodiments, the starch is pregelatinized or agglomerated or both. In other embodiments the starch is a thermally inhibited starch that is pregelatinized or agglomerated or both according to the methods described in this specification. In still other embodiments the starch is agglomerated and then thermally inhibited or pregelatinized or both. In any embodiment of a food composition described in this specification the composition comprises a starch and a second ingredient wherein the starch is used in any amount for example in an amount from about 1% to about 99% by weight of the food composition.

In any embodiment, a food composition includes as a second ingredient a sweetener. Useful sweeteners include, but are not limited to, dextrose, allulose, tagatose, fructose, glycerol, sucrose, erythritol, rebaudiosides (A, B, J, M, etc.), glucosylated stevia glycosides, and corn syrups including high fructose corn syrups, and mixtures thereof. Sweeteners may be provided in solid, or powdered, or liquid, or syrup form.

In any embodiment, a food composition includes as a second ingredient a gum or gum-like material. Useful gums and gum like materials include, but are not limited to, gelling starches, gum Arabic, xanthan gum, tara gum, konjac, carrageenan, locust bean gum, gellan gum, guar gum, and mixtures thereof.

In any embodiment, a food composition includes as a second ingredient an oil, or fat, or aqueous ingredient. Useful oils include, but are not limited to, vegetable oils such as corn oil, olive oil, canola oil, sunflower oil, rapeseed oil, palm oil, coconut oil, and mixtures thereof. Useful fats (other than vegetable oils), for example, included animal fats and dairy fats. Useful aqueous ingredients include, for example, water, milk, syrups, or other carbohydrate containing liquids, or acidic liquids, or basic liquids.

In any embodiment, a food composition including a as described in this specification may further comprises various other flavorings, seasonings and colorings commonly used in food composition.

In any embodiment, a food composition is an aqueous composition where an cold water swellable starch is useful including, but not limited to dressings including pourable dressings and spoonable dressings, pie fillings including fruit fillings (and other similar fruit preparations whether used in pies) and cream fillings, sauces, including white sauces and dairy-based sauces such as cheese sauces, gravies, imitation and lite syrups, puddings, custards, yogurts, sour creams, pastas, beverages including dairy-based beverages, glazes, soups and baby food.

Reference to “waxy starch” in this specification means low amylose starch—i.e. less than about 5% or less than about 3% or essentially 0% amylose. Depending on the botanical source the ratio of amylose to amylopectin may vary. Plants, however, can be bred so that essentially all the starch produced is amylopectin. Such breeds can be referred to in the industry as waxy variants, for example, waxy corn or waxy rice. Commonly waxy plant varieties are bred to produces less than about 5% amylose (wt. %) and more commonly essentially 0% amylose.

Reference to “native” starch in this specification means a starch that is not modified, for example using physical, chemical, or enzymatic processes. Commonly, native starch and native flour can be identified by microscopic inspection of the starch (or starch within the flour) because native starches have a crystalline structure that creates a Maltese cross-like diffraction pattern when viewed under polarized light. In contrast, gelatinized (and pregelatinized) starch has no crystallinity and so has no distinguishable diffraction pattern when viewed under polarized light.

The term “pregelatinized” starch and its grammatical variants are known terms in the art and are used in this specification according to their full meaning in the art. Without limiting the full understanding of the meaning of the term pregelatinized, reference is made to the following properties of pregelatinized starches to facilitate understanding the technologies described in this specification. Pregelatinized starches are precooked to destroy starch's native granular structure. The pregelatinization process can be applied to native or modified starch including thermally inhibited starches. Starch is pregelatinized so that it can provide its intended function, for example providing viscosity to an aqueous solution, without further cooking. In this sense, pregelatinized starch may be referred to in the art as instant starch or cold-water swellable starch or cold-water soluble starch or precooked starch. Whether starch is pregelatinized can be determined by viewing the starch under polarized light. Granular starch exhibits a Maltese cross diffraction pattern. Non-granular starch does not. Also, at ambient pressure, starch pregelatinizes at different temperature depending at least on botanical source, and whether and how a starch is modified. Generally, however, at ambient pressure, starch pregelatinizes at temperatures between 60° and 80° C.

Reference to “precooking starch” means processing starch so that it is heated to any temperature up to and including the point where the starch is completely pregelatinized, and then recovered in a solid form. A precooked starch can be partially pregelatinized or completely pregelatinized.

Reference to “saturated steam” in this specification is steam at a temperature higher than the vaporization point of its liquid state, at the absolute pressure where the temperature is measured. For example, under normal (sea level) environmental conditions, water has a vaporization point (also known as boiling point) at about 100° C. A saturated steam composed of water would have a temperature greater than about 100° C., under normal environmental conditions.

Reference to “thermally inhibited” starch in this specification means starch made in a process that alters the function of the native starch so that it functions in aqueous solution like chemically crosslinked starch. How much a starch is thermally inhibited can be evaluated using a micro-visco-amylograph test. Such test (defined below) measures how the viscosity of a slurry changes over time as a starch slurry is heated. Thermally inhibited starch can be made to have varying degree of inhibition. For example, within this specification, starch is referred to as lightly, moderately, and highly inhibited. In practice, thermally inhibited starches are chosen for a food application based on the processing conditions used to make the food application. More specifically, inhibited starch is chosen so it will most likely provide constant viscosity through process of making a food product. For example, more highly thermally inhibited starch is used if harsher food processing conditions are used.

Within this specification, “lightly”, “moderately”, and “highly” inhibited thermally inhibited starch are described using micro-visco-amylograph test at pH 6 according to the highest viscosity during the heating phase (“peak hot viscosity”). Although not necessary to meet the definition of thermally inhibited, in preferred embodiments, a thermally inhibited starch has no viscosity breakdown during the heating phase of the visco-amylograph or micro-visco-amylograph made by Brabender® GmbH & Co. KG. Also, with reference to various preferred embodiments a slurry can have “no viscosity breakdown” because the viscosity remains steady at a peak viscosity or viscosity increases while the slurry is held at 95° C. for 15 minutes, spindle speed is 75 RPM. Within this context, as used in this specification, “lightly thermally inhibited starch” has a peak hot viscosity of greater than 800 to 1600 mPa*s. “Moderately thermally inhibited starch” has a peak hot viscosity between 300 and 800 mPa*s. “Highly thermally inhibited starch” has a peak hot viscosity less than 300 mPa*s. Brabender visco-amylographs or micro-visco-amylographs commonly can report viscosity measurements using Brabender units (BU) mPA*s, or cmg.

Reference to a “micro-visco-amylograph test” within this specification means the following test. Obtain aqueous slurry of starch by mixing 6% (wt. %) starch with aqueous solution that was buffered, and pH adjusted to pH 6. Heat and stir the slurry using Brabender visco-amylograph or micro-visco-amylograph machine rotating at a rate of 75 rpm at a rate of 6° C. per minute from a temperature of about 50° C. to about 95° C. and hold the slurry at 95° C. for 15 minutes. Combined, the heating from 50° to 95° and holding at 95° are referred to in this specification as the “heating phase” of the micro-visco-amylograph test. A useful attribute of the slurry for determining degree of inhibition is the peak hot viscosity, which is the highest viscosity obtained during the heating phase of the test. The micro-visco-amylograph test may end once the heating phase is complete. Although not necessary for this definition, a micro-visco-amylograph test may continue after completing the heating phase of the test. Generally, during this phase the slurry cools under ambient or controlled conditions until the slurry approaches ambient temperate and a final steady state viscosity (or gelled composition), called in this specification “cooling phase.” The cooling phase may run for any desired amount of time but is usually completed within about 30 minutes after heating is stopped, which is about one-hour total from the test's beginning.

Reference to a “single phase process” within this specification means a process that adds moisture (aqueous solution) to starch or flour in an amounts where all the solution is absorbed by the starch or flour such that there exists within the mixture only a solid phase, although the solid phase may appear wet and may be present as a cake or clump of material. Here phase refers to a state of matter, so the system has a single phase because all liquid or gas (steam) is absorbed and only the single solid phase of starch is present. A single-phase process is distinguished from a process that adds an excess of moisture creating a slurry where there exist two distinct states of matter, a solid (starch) and liquid phase.

With reference to usage, this specification refers thermally inhibited agglomerated starch, which is agglomerated starch that is then thermally inhibited. This specification also refers to and agglomerated thermally inhibited starch, which refers to thermally inhibited starch that is then agglomerated.

Use of “about” to modify a number is meant to include the number recited plus or minus 10%. Where legally permissible recitation of a value in a claim means about the value. Use of about in a claim or in the specification is not intended to limit the full scope of covered equivalents.

Recitation of the indefinite article “a” or the definite article “the” is meant to mean one or more unless the context clearly dictates otherwise.

While certain embodiments have been illustrated and described, a person with ordinary skill in the art, after reading the foregoing specification, can effect changes, substitutions of equivalents and other types of alterations to the methods, and of the present technology. Each aspect and embodiment described above can also have included or incorporated therewith such variations or aspects as disclosed regarding any or all the other aspects and embodiments.

The present technology is also not to be limited in terms of the aspects described herein, which are intended as single illustrations of individual aspects of the present technology. Many modifications and variations of this present technology can be made without departing from its spirit and scope, as will be apparent to those skilled in the art. Functionally equivalent methods within the scope of the present technology, in addition to those enumerated herein, will be apparent to those skilled in the art from the foregoing descriptions. Such modifications and variations are intended to fall within the scope of the appended claims. It is to be understood that this present technology is not limited to methods, conjugates, reagents, compounds, compositions, labeled compounds or biological systems, which can, of course, vary. All methods described herein can be performed in any suitable order unless otherwise indicated herein or otherwise clearly contradicted by context. It is also to be understood that the terminology used herein is for the purpose of describing aspects only and is not intended to be limiting. Thus, it is intended that the specification be considered as exemplary only with the breadth, scope and spirit of the present technology indicated only by the appended claims, definitions therein and any equivalents thereof. No language in the specification should be construed as indicating any non-claimed element as essential.

The embodiments illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

In addition, where features or aspects of the disclosure are described in terms of Markush groups, those skilled in the art will recognize that the disclosure is also thereby described in terms of any individual member or subgroup of members of the Markush group. Each of the narrower species and subgeneric groupings falling within the generic disclosure also form part of the technology. This includes the generic description of the technology with a proviso or negative limitation removing any subject matter from the genus, regardless of whether the excised material is specifically recited herein.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member, and each separate value is incorporated into the specification as if it were individually recited herein.

The technology disclosed in this specification can be better understood with reference to the following aspects which are provided for illustrative purposes and are not intended to be limiting in any way.

A method for processing starch comprising: providing a starch and applying a hot aqueous fluid to the starch in an amount up to about 45% (wt. % of the starch).

The method of claim of claim 1 wherein the hot aqueous fluid is applied to the starch in an amount from about 10% to about 20% or from about 10% to about 15%; wherein the method agglomerates the starch, and wherein the hot aqueous fluid is a binding agent.

The method of claim 1 wherein the hot aqueous fluid is applied in an amount from about 20%, or from about 25%, or from about 30%, or from about 35%, to about 45% or to about 40%. and wherein the hot aqueous fluid precooks, wherein, optionally the starch is pregelatinized such that the starch does not exhibit a Maltese cross diffraction pattern when viewed under polarized light.

The method of any one of claims 1 to 3 further comprising drying the agglomerated or pre-cooked starch to have a moisture content of up to about 15% or from about 4%, or from about 6%, or from about 8% to about 15%, or to about 12% (wt. %).

The method of any one of claims 1 to 4 wherein the starch is from the group consisting of corn, waxy corn, rice, waxy rice, tapioca, waxy tapioca, potato, waxy potato, pea, chickpea, lentil, fava bean, quinoa, sago, and mixtures thereof.

The method of any one of claims 1 to 5 wherein the hot aqueous fluid is applied to a native starch.

The method of any one of claims 1 to 6 wherein the hot aqueous fluid is applied to a modified starch, wherein preferably, the modification is thermal inhibition.

The method of any one of claims 1 to 7 wherein the starch has a moisture of less than 2% (wt. %) and wherein, optionally the starch is a thermally inhibited starch.

The method of any one of claims 1 to 8 wherein the hot aqueous fluid is applied to the starch in an amount from about 10% to about 20% or from about 10% to about 15%, wherein the starch is a native starch, the method further comprising: the hot aqueous fluid being applied to the starch further comprises a buffering agent and an acid or a base so that following applying the hot aqueous fluid, the starch is an agglomerate starch, that is buffered, and pH adjusted the starch to a pH between about 4.5 and about 9.5, wherein preferably the starch is adjusted to a pH from about 4.5 to about 7.0, and wherein more preferably, the starch is adjusted to a pH from about 4.5 to about 5.5; dehydrating the agglomerated, buffered, pH adjusted starch to a moisture content of less than about 2% (wt. % of the starch) to provide a starch agglomerate; and heat treating the anhydrous or substantially anhydrous starch agglomerate at a temperature of about 100° C. to about 200° C. for up to about 20 hours thereby thermally inhibiting the starch agglomerates to obtain a thermally inhibited agglomerated starch.

The method of any one of claims 1 to 9 wherein the hot aqueous fluid is applied to a thermally inhibited starch; and wherein optionally, the thermally inhibited starch has a peak hot viscosity as measured using a micro-visco-amylograph test of less than about 2000 mPa*s, or less than about 1500 mPa*s, or in a range selected from the group consisting of a) less than about 300 mPa*s, b) from about 300 mPa*s to about 300 mPa*s, and c) from about 800 mPa*s to about 1600 mPa*s.

The method of any one of claims 1 to 10 wherein the hot aqueous fluid is applied to a thermally inhibited starch in an amount from about 10% to about 20% or from about 10% to about 15% to obtain an agglomerated thermally inhibited starch, and if necessary, drying the agglomerated thermally inhibited starch to a moisture content from about 10% to about 15% (wt. % of the starch).

The method of any one of claims 1 to 11 wherein the hot aqueous fluid is applied to a thermally inhibited starch in an amount from about 20% to about 40%, or from about 25% to about 40% to obtain a pregelatinized thermally inhibited starch; wherein optionally, the pregelatinized thermally inhibited starch is dried to a moisture content of up to about 15% or from about 4%, or from about 6%, or from about 8% to about 15%, or to about 12% (wt. %).

The method of anyone of claims 1 to 12 further comprising forming an agglomeration of thermally inhibited starch by applying hot aqueous fluid to a thermally inhibited starch in a first amount, which is within the up to about 40% (wt. % of the starch); and pregelatinizing the agglomerated thermally inhibited starch by applying hot aqueous fluid to the thermally inhibited agglomerated starch in a second amount which is greater than the first amount but is within the up to about 40% (wt. % of the starch); wherein, optionally the pregelatinized agglomerated thermally inhibited starch is dried to a moisture content of up to about 15% or from about 4%, or from about 6%, or from about 8% to about 15%, or to about 12% (wt. %).

The method of anyone of claims 1 to 13 wherein the hot aqueous fluid is applied to a thermally inhibited starch having a moisture content of less than about 2% (wt. % of the starch).

The method of any one of claims 1 to 14 wherein the hot aqueous fluid is applied to the starch in one or more of a fluid bed reactor or a hollow tube reactor.

The method of any one of claims 1 to 15 wherein the starch is agglomerated or pregelatinized and is dried in same reactor.

The method of any one of claims 1 to 16 wherein the starch is agglomerated or pregelatinized and is dried in different reactors.

The method of any one of claims 1 to 17 wherein the hot aqueous fluid has a temperature from about 70°, or from about 75°, or from about 80°, or from about 85, or from about 90°, or from about 95°, or to about 99° C., or from about 70° C. to about 99°, or to about 95°, or to about 90°, or to about 85°, or to about 80°, or to about 75°.

The method of any one of claims 1 to 18 wherein the hot aqueous fluid is saturated steam.

The method of any one of claims 1 to 19, wherein the hot aqueous fluid has a temperature greater than about 100° C. or greater than about 110° C. or greater than about 120° C. or from about 100° C. to about 200° C. or to about 190° C. or to about 180° C. or to about 170° C. or to about 160° C. or to about 150° C.

A pregelatinized thermally inhibited starch or pregelatinized agglomerated thermally inhibited starch made according to the process as described in any foregoing claim.

The pregelatinized thermally inhibited starch or pregelatinized agglomerated thermally inhibited starch as described in claim 21 wherein an aqueous starch slurry having a 6% starch solids and pH 6 obtains, without heating the slurry, a viscosity less than about 2000 mPa*s or less than about 1500 mPa*s or in a range selected from the group consisting of a) less than about 300 mPa*s, b) from about 300 mPa*s to about 800 mPa*s, and c) from about 800 mPa*s to about 1600 mPa*s.

A food product comprising a starch made by a process described in any forgoing claim and a second edible ingredient; wherein, preferably, the starch is a pregelatinized thermally inhibited starch or a pregelatinized agglomerated thermally inhibited starch.

The technology disclosed in this specification can be better understood with reference to the following Examples, which are provided for illustrative purposes and are not intended to be limiting in any way

### EXAMPLE 1—THERMALLY INHIBITED PREGELATINIZED STARCH AND PROCESSES FOR MAKING THEM

The differences among pregelatinized thermally inhibited starches that were pregelatinized using one of drum drying, spray drying, or the single-phase methods described in this specification are depicted in the following examples.

### EXAMPLE 1A—DRUM DRIED PREGELATINIZED THERMALLY INHIBITED STARCH

Drum drying processes are known in the art, and generally work by applying a thin film of a starch slurry to a rotating heated drum. The drum cooks the starch in the slurry, pregelatinizing it, and evaporates the moisture from the slurry. The pregelatinized, dried starch is scraped off the drum, providing the end-product a flake-like, partially intact, partially sheared starch granule shape (although the starch is not granular in the sense that granular starch exhibits a Maltese cross starch diffraction pattern when viewed under polarized light; drum dried starch does not exhibit a Maltese diffraction pattern when viewed under polarized light). Drum dried starches are commonly milled to obtain a specified particle size. With reference to commercial pregelatinized starches available from Ingredion Incorporated, coarser grinds may have a particle size distribution such that about 55% (by volume) of particles will settle on a 200-mesh (74 micron pore size) sieve and finer grinds may have a particle size distribution where at most about 1.0% of particles will settle on a 500-mesh (25 micron pore size) sieve. In food products, rehydrated drum dried starches can have a pulpy texture, which can be made less noticeable by using finer grind drum dried starch products.

FIG. 1 is a photograph of a drum dried thermally inhibited waxy cassava starch available from Ingredion Incorporated, after staining with iodine. The starch was prepared by hydration of a drum thermally inhibited waxy cassava starch in fruit juice (7% starch in juice, dry basis) for 33 minutes. Then, 0.1 g of starch in fruit juice dispersion was mixed with 0.1 g iodine solution (calculated as follows: 6.5 g potassium iodide+1.3 g Iodine/100 mL deionized water, solution from JT Baker). The stained starch was viewed at 100× magnification with use of a polarizing filter. With reference to FIG. 1, no Maltese cross diffraction patterns were present in the starch granules, demonstrating that the starch was pregelatinized. Note that many jagged and small shapes were seen, indicating that the shearing from drum has torn apart much of the starch.

### EXAMPLE 1B—SPRAY COOKED PREGELATINIZED THERMALLY INHIBITED STARCHES

Spray cooking processes are known, and generally work by forcing a starch slurry through a narrow annular aperture while cooking the starch using high temperature steam. The steam passes through a circular steam aperture and travels radially out toward and across the flow of the starch slurry. This cooks the starch and simultaneously pregelatinizes it. The pregelatinized starch slurry then passes through an atomizing nozzle, to recover the starch. The particle size of the spray cooked starch is controlled by nozzle size, which can be confirmed by visual inspection.

FIG. 2 is a photograph of a spray dried thermally inhibited waxy cassava starch, after staining with iodine. The starch was prepared for magnification using the same method as the starch shown in FIG. 1 (hydration a drum thermally inhibited waxy cassava starch in fruit juice (7% starch in juice, dry basis) for 33 minutes. Then, 0.1 g of starch in fruit juice dispersion was mixed with 0.1 g iodine solution (calculated as follows, 6.5 g potassium iodide+1.3 g Iodine/100 mL deionized water, solution from JT. Baker)). With reference to FIG. 2, no Maltese cross diffraction patterns were present in the starch granules, confirming that the starch was pregelatinized. As seen, although irregularly shaped, the starch had generally smoother surfaces than the drum dried thermally inhibited waxy corn starch of starch of FIG. 1. This comparative lack of jagged edges showed that the spray cooked starch remained mostly intact and showed less signs of shearing (fragmentation) than starch products obtained by the drum drying method.

### EXAMPLE 1C—SINGLE-PHASE PREGELATINIZED THERMALLY INHIBITED STARCHES (PROPHETIC EXAMPLE)

In preferred embodiments of the described process, thermally inhibited starch is pregelatinized in a single-phase process using hollow-tube reactor, such as a CoriMix reactor available from Gebrüder Lödige Maschinenbau GmbH. Hot water is fed into the reactor to rehydrate the starch in amounts described in this specification. More specifically, water is added to provide enough moisture to the starch so that it pregelatinizes in the heat supplied by the CoriMix reactor. A preferred process starts with a thermally inhibited starch that has not been remoistened and so has moisture content less than about 2% (wt. %), and adds enough hot water so that the starch is hydrated to greater than 20% or greater than 30% up to about 45% moisture (wt. %).

In operation, a CoriMix reactor impels starch through the length of the hollow-tube, which applies shear to the starch as it pregelatinizes. It is expected, however, that the damage to the starch resulting from the shear will be less than observed for drum drying because, unlike drum drying, the starch is not slurried in water, but exists in a single phase during the process. Accordingly, it is expected the products pregelatinized in a single-phase process have an appearance that is less jagged and torn than drum dried pregelatinized thermally inhibited starch and more jagged and torn than a spray cooked pregelatinized thermally inhibited starch. It is further expected the starch will provide equivalent viscosity to either spray dried or drum dried starch but provide a less pulpy texture than finely ground drum dried thermally inhibited starches, for example having about 500 mesh.

1. A method for processing starch comprising: providing a starch and applying a hot aqueous fluid to the starch in an amount up to about 45% (wt. % of the starch) wherein the hot aqueous fluid precooks such that the starch is pregelatinized and does not exhibit a Maltese cross diffraction pattern when viewed under polarized light.

2. (canceled)

3. The method of claim 1 wherein the hot aqueous fluid is applied in an amount from about 20%, to about 45%.

4. The method of claim 1 further comprising drying the starch to have a moisture content of up to about 15%.

5. The method of claim 1 wherein the starch is from the group consisting of corn, waxy corn, rice, waxy rice, tapioca, waxy tapioca, potato, waxy potato, pea, chickpea, lentil, fava bean, quinoa, sago, and mixtures thereof.

6. The method of claim 1 wherein the hot aqueous fluid is applied to a native starch.

7. The method of claim 1 wherein the hot aqueous fluid is applied to a modified starch, wherein preferably, the modification is thermal inhibition.

8. (canceled)

9. The method claim 1 wherein the starch is a thermally inhibited agglomerated starch, the method further comprising prior to the applying step of claim 1 doing each of sub steps a to c:
a. applying a hot aqueous fluid to a native starch in an amount from about 10% to about 20% wherein the hot aqueous fluid comprises a buffering agent and an acid or a base so that following applying the hot aqueous fluid, the starch is an agglomerate starch, that is buffered and pH adjusted to a pH between about 4.5 and about 9.5;
b. dehydrating the agglomerated, buffered, pH adjusted starch to a moisture content of less than about 2% (wt. % of the starch) to provide a starch agglomerate; and
c. heat treating the dehydrated starch agglomerate at a temperature of about 100° C. to about 200° C. for up to about 20 hours thereby thermally inhibiting the starch agglomerates to obtain the thermally inhibited agglomerated starch.

10. The method of claim 1 wherein the pregelatinized starch is a thermally inhibited starch; having a peak hot viscosity as measured using a micro-visco-amylograph test of less than about 2000 mPa*s.

11. (canceled)

12. The method of claim 1 wherein the hot aqueous fluid is applied to a thermally inhibited starch and the pregelatinized thermally inhibited starch is dried to a moisture content of up to about 15%.

13. The method of claim 1 wherein the applying a hot aqueous fluid to the starch in an amount up to about 45% comprises applying the fluid in first and second amounts and wherein the method further comprises
a. forming an agglomeration of thermally inhibited starch by the applying hot aqueous fluid to a thermally inhibited starch in a first amount, which is within the up to about 45% (wt. % of the starch); and
b. pregelatinizing the agglomerated thermally inhibited starch by applying the hot aqueous fluid to the thermally inhibited agglomerated starch in a second amount which is greater than the first amount but is within the up to about 45% (wt. % of the starch);
and wherein, the pregelatinized agglomerated thermally inhibited starch is dried to a moisture content of up to about 15%.

14. The method of claim 1 wherein the hot aqueous fluid is applied to a thermally inhibited starch having a moisture content of less than about 2% (wt. % of the starch).

15. The method of claim 1 wherein the hot aqueous fluid is applied to the starch in a hollow tube reactor.

16. The method of claim 1 wherein the starch is agglomerated or pregelatinized and is dried in same reactor.

17. The method of claim 1 wherein the starch is agglomerated or pregelatinized and is dried in different reactors.

18. The method of claim 1 wherein the hot aqueous fluid has a temperature from about 70°, to about 99°.

19. The method of claim 1 wherein the hot aqueous fluid is saturated steam.

20. The method of claim 1, wherein the hot aqueous fluid has a temperature greater than about 100° C.

21. A pregelatinized thermally inhibited starch made according to the process as described in claim 1.

22. (canceled)

23. (canceled)
